(19) United States
(12) Patent Application Publication
(10) Pub. No.: US 2002/0013441 A1
(43) Pub. Date: Jan. 31, 2002

(54) Process for the preparation of silarylenesiloxane-diorganosiloxane copolymers

(75) Inventors: Philipp Muller, burghausen (DE); Norbert Egerter, Mehring/Od (DE)

Correspondence Address: William G. Conger, Brooks & Kushman P.C., 22nd Floor, 1000 Town Center, Southfield, MI, 48075-1351, US

(73) Assignee: Wacker-Chemie GmbH, Munchen (DE)

(21) Appl. No.: 09/881,388

(22) Filed: Jun. 13, 2001

(30) Foreign Application Priority Data
Jun. 23, 2000 (DE) 100 30 686.1

(51) Int. Cl. C08G 77/00

(52) U.S. Cl. 528/10

(57) ABSTRACT

Linear-chain copolysiloxanes comprising units of the general formulae (1) and (2),

[—(R¹R²SiO)ₐ—] (1),

[—(R³R⁴Si—R⁷—SiR⁵R⁶O)_{b}—R³R⁴Si—R⁷—SiR⁵R⁶—] (2),

the end-groups of which may be Si—H or Si—OH, are prepared by reacting:

(A) diorganopolysiloxanes of the general formula (3)

HO—(R¹R²SiO)ₐ—H (3)

with

(B) silarylenesiloxane compounds of the general formula (4)

H—[(R³R⁴Si—R⁷—SiR⁵R⁶O)_{b}—R³R⁴Si—R⁷—SiR⁵R⁶]—H (4),

in the presence of (C) a transition metal catalyst, wherein R¹, and R² are optionally substituted and optionally heteroatom-containing hydrocarbon radicals, R³, R⁴, R⁵, and R⁶ are optionally halogen-substituted and optionally heteroatom-containing aliphatically or aromatically unsaturated C₁₋₂₀ hydrocarbon radicals, and R⁷ is an aromatic, optionally substituted, and optionally heteroatom-containing divalent hydrocarbon radical. The copolysiloxanes are well defined, and have internal blocks corresponding to the (3) and (4) starting materials, substantially free of rearrangement and equilibration products.

### BACKGROUND OF THE INVENTION

1. Field of the Invention

The invention relates to a process for the preparation of silarylenesiloxane-diorganosiloxane copolymers. The linking of the comonomer blocks of the copolymers involves a transition-metal-catalyzed dehydrogenolysis reaction between hydridosilyl and hydroxysilyl groups on the terminal silicon atoms of silarylenesiloxane blocks and polydimethylsiloxane blocks.

2. Background Art

Processes for the preparation of block copolymers containing dimethylsiloxane and dimethylsilarylenesiloxane blocks are known in the art. U.S. Pat. No. 3,202,634 is believed to be the first to disclose the formation of such block copolymers, by a condensation reaction of silanol-terminated dimethylsiloxane oligomers and silanol-terminated dimethylsilarylenesiloxane oligomers. The formation of copolymers by a condensation reaction requires the use of a condensation catalyst. A disadvantage of using such catalysts is the well-known lability of the siloxane bond toward equilibration, i.e. these catalysts facilitate the rearrangement of the defined siloxane backbone of the block copolymers to produce randomly distributed copolymers. Thus, the potentially high specificity of a block copolymer obtained through deliberate selection of the reactive oligomers is lost by the catalyst-dependent equilibration reaction. A further disadvantage is the complex preparation of the silanol-terminated silarylenesiloxane blocks by condensation of dimethylsilanol-terminated aromatic silane monomers, which are accessible only via a multistage synthesis route.

U.S. Pat. No. 3,674,739 describes a process which claims the reaction of bisorganoaminosilarylenes with silanol-terminated polydimethylsiloxanes. However, the formation of defined block copolymer structures is not described. A further disadvantage of the process of U.S. Pat. No. 3,674,739 is the liberation of dialkylamines in the condensation.

Kawakami et al (Macromolecules 199, 32, 3540-3542) describes the formation of high molecular weight poly[(oxydimethylsilylene)-(1,4-phenylene)(dimethylsilylene)] by a transition-metal-catalyzed dehydrogenolysis reaction of 1,4-bis(dimethylsilyl)benzene with water.

None of the known processes permits the predictable, defined formation of block copolymers in which the sequence lengths of the copolymer blocks corresponds to the block lengths of the reactive oligomers used.

### SUMMARY OF THE INVENTION

The present invention provides a process for the preparation of essentially linear block copolymers with predictable block lengths, by reacting an organopolysiloxane bearing terminal silanol groups with a silarylenesiloxane bearing terminal Si—H functionality in the presence of a transition metal catalyst.

### DETAILED DESCRIPTION OF THE PREFERRED EMBODIMENTS

The invention thus provides a process for the preparation of essentially linear block copolysiloxanes consisting of units of the general formulae (1) and (2),

[—(R¹R²SiO)ₐ—] (1),

[—(R³R⁴Si—R⁷—SiR⁵R⁶O)_{b}—R³R⁴Si—R⁷—SiR⁵R⁶—] (2),

the end-groups of which are chosen from Si—H and Si—OH, in which

(A) diorganopolysiloxanes of the general formula (3)

HO—(R¹R²SiO)ₐ—H (3)

are reacted with

(B) silarylenesiloxane compounds of the general formula (4)

H—[(R³R⁴Si—R⁷—SiR⁵R⁶O)_{b}—R³R⁴Si—R⁷—SiR⁵R⁶]—H (4),

where, in the general formulae (1) to (4),

R¹ and R² are individually selected from monovalent, optionally halogen-substituted, optionally O-, N-, S-, or P-atom-containing, and optionally aliphatically unsaturated hydrocarbon radicals having 1 to 20 carbon atoms;

R³, R⁴, R⁵ and R⁶ are individually selected from monovalent, optionally halogen-substituted, optionally O-, N-, S-, or P-atom-containing, and optionally aliphatically or aromatically unsaturated hydrocarbon radicals having 1 to 20 carbon atoms;

R⁷ is a divalent, aromatically unsaturated, optionally halogen-substituted, optionally O-, N-, S- or P-atom-containing hydrocarbon radical having 6 to 100 carbon atoms;

a is an integer from 1 to 1000; and

b is an integer from 0 to 100, in the presence of

(C) at least one transition metal catalyst.

The process ensures a defined formation of the copolymer structure of the linear-chain copolysiloxanes. The linking of the reactive oligomers of dimethylsiloxane (A) and silarylenesiloxane blocks (B) takes place by a dehydrogenolysis reaction between the terminal hydridosilyl groups of the silarylenesiloxane chain and terminal hydroxysilyl groups of the dimethylsiloxane chain with the elimination of hydrogen and the formation of a new siloxane bond. This reaction is slightly exothermic and requires a suitable transition metal catalyst for the activation of the hydridosilyl functionality.

A particular advantage of the process of the invention is the high selectivity of the reaction, as a result of which equilibration and regrouping of the siloxane starting materials are substantially excluded. Thus, the copolysiloxanes prepared by the method of the invention contain identical sequence lengths of the diorganosiloxane (A) and silarylenesiloxane oligomers (B) used. No regroupings or equilibrations of the siloxane bonds between the diorganosiloxane (A) and silarylenesiloxane blocks (B) have been observed. The resulting block length distribution within the copolymer can be adjusted through the choice of the hydroxy-terminated diorganopolysiloxane (A) and the hydridosilyl-terminated silarylenesiloxane (B). The high selectivity, with the exclusion of regroupings of the siloxane backbone between the various comonomer blocks results in improved property profiles of the siloxane elastomers prepared using the linear-chain copolysiloxanes.

A further particular advantage of neutral transition metal catalysts, which are, inter alia, also used for the catalysis of hydrosilylation reactions, is their inactivity with regard to the catalysis of the equilibration of siloxane bonds. In the subject invention process, the use of neutral catalysts such as those based on platinum with an oxidation state 0, prevents regrouping of the linked siloxane blocks. For this reason, block copolymers having the identical sequence lengths of the reactive oligomers (A) and (B) are obtained in the present process.

A yet further advantage of the process of the invention is the possibility of preparing the linear-chain copolysiloxanes without the addition of solvents, which is obligatory in the previously described processes.

Examples of the radicals R¹ and R² are alkyl radicals such as the methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl and octadecyl radicals; cycloalkyl radicals such as the cyclopentyl, cyclohexyl, cycloheptyl, norbornyl, adamantylethyl or bornyl radicals; aryl or alkaryl radicals such as the phenyl, ethylphenyl, tolyl, xylyl, mesityl and naphthyl radicals; aralkyl radicals such as the benzyl, 2-phenylpropyl and phenylethyl radicals, and also derivatives of the above radicals which are halogenated and/or functionalized with organic groups, such as the 3,3,3-trifluoropropyl, 3-iodopropyl, 3-isocyanatopropyl, aminopropyl, methacryloxymethyl and cyanoethyl radicals.

Examples of unsaturated radicals are alkenyl and alkynyl radicals such as the vinyl, allyl, isopropenyl, 3-butenyl, 2,4-pentadienyl, butadienyl, 5-hexenyl, undecenyl, ethynyl, propynyl and hexynyl radicals, cycloalkenyl radicals such as the cyclopenentyl, cyclohexenyl, 3-cyclohexenylethyl, 5-bicycloheptenyl, norbornenyl, 4-cyclooctenyl and cyclooctadienyl radical and alkenylaryl radicals. Preferred radicals R¹ and R² contain 1 to 10 carbon atoms and optionally halogen substituents. Particularly preferred radicals R¹ and R² are the methyl, phenyl and 3,3,3-trifluoropropyl radicals, in particular the methyl radical.

Examples of the radicals R³, R⁴, R⁵ and R⁶ include alkyl radicals such as the methyl, ethyl, propyl, isopropyl, tert-butyl, n-octyl, 2-ethylhexyl and octadecyl radicals, and cycloalkyl radicals such as cyclopentyl, cyclohexyl, norbornyl and bornyl radicals. Further examples of R³, R⁴, R⁵ and R⁶ are the phenyl, tolyl, xylyl, biphenylyl, anthryl, indenyl, phenanthryl, naphthyl, benzyl, phenylethyl and phenylpropyl radicals, and derivatives of the above radicals which are halogenated and/or functionalized with organic groups, such as the o-, m-, p-chlorophenyl, pentafluorophenyl, bromotolyl, trifluorotolyl, phenoxy, benzyloxy, benzyloxyethyl, benzoyl, benzoyloxy, p-tert-butylphenoxypropyl, 4-nitrophenyl, quinolyl and pentafluorobenzoyloxy radicals. Preferred radicals R³, R⁴, R⁵ and R⁶ are hydrocarbon radicals having 1 to 10 carbon atoms. A particularly preferred radical is the methyl radical.

A preferred radical R⁷ corresponds to the general formula (5)

—(O)ₛ—(R⁸)ₜ—(O)ᵤ—(X)_{w}—(O)ᵤ—(R⁸)ₜ—(O)ₛ—, (5),

where

s and u are 0 or 1,

t is 0, 1 or 2,

w is 1 or 2,

R⁸ is a bivalent, optionally halogen-substituted, optionally O-, N-, S- or P-atom-containing hydrocarbon radical free from aliphatically unsaturated groups and containing 1 to 10 carbon atoms, such as —CH₂—, —CH₂—CH₂—, —CH₂—CH₂—CH₂—, —CF₂—, —CH₂—CF₂—, —CH₂—CH(CH₃)—, —C(CH₃)₂—, —CH₂—C(CH₃)₂—, —C(CH₃)₂—or CH₂—, and

X is a bivalent radical chosen from —Ph—, —Ph—O—Ph—, —Ph—S—Ph—, —Ph—SO₂—Ph—, —Ph—C(CH₃)₂—Ph—, Ph—C(CF₃)₂—Ph—, —Ph—C(O)—Ph—, cyclohexylene or norbornylene, where —Ph— is a phenylene group. A particularly preferred radical R⁷ is the phenylene radical.

The viscosity of the silarylenesiloxane compounds (B) determined at 25° C. is preferably 1 mPa·s to 1,000,000 mPa·s, more preferably 2 mPa·s to 100,000 mPa·s. The viscosity of the diorganopolysiloxanes (A), determined at 25° C., is also preferably 1 mPa·s to 1,000,000 mPa·s, more preferably 2 mPa·s to 100,000 mPa·s.

A transition metal catalyst (C) serves as catalyst for the condensation reaction, referred to as a “dehydrogenolysis”, between the silanol groups of the silanol-terminated diorganopolysiloxanes (A) and the hydridosilyl groups of the hydridosilyl-terminated silarylene-polysiloxanes (B). Known hydrosilylation catalysts are particularly suitable for this purpose. The literature describes numerous hydrosilylation catalysts. In principle, it is possible to use all hydrosilylation catalysts which have employed previously, or which may become available in the future. As dehydrogenolysis catalyst (C), for example, it is possible to use metals such as platinum, rhodium, palladium, ruthenium and iridium, preferably platinum, and compounds of these metals as well. The metals can optionally be supported on finely divided carrier materials such as activated carbon or metal oxides such as aluminum oxide and silicon dioxide.

Transition metal catalysts based on platinum have proven to be particularly active. Preference is therefore given to using platinum and platinum compounds. Particular preference is given to those platinum compounds which are soluble in polyorganosiloxanes. As soluble platinum compounds, it is possible, for example, to use the platinum/olefin complexes of the formulae (PtCl₂.olefin)₂ and H(PtCl₃.olefin), preference being given to using, as the olefin, alkenes having 2 to 8 carbon atoms, such as ethylene, propylene, isomers of butene and octene, or cycloalkenes having 5 to 7 carbon atoms, such as cyclopentene, cyclohexene and cycloheptene. Further soluble platinum catalysts are the platinum/cyclopropane complex of the formula (PtCl₂C₃H₆)₂; the reaction product of hexachloroplatinic acid with alcohols, ethers or aldehydes or mixtures thereof; or the reaction product of hexachloroplatinic acid with methylvinylcyclotetrasiloxane in the presence of sodium bicarbonate in ethanolic solution. It is also possible to use platinum catalysts having phosphorus, sulfur and amine ligands, e.g. (Ph₃P)₂PtCl₂. Particular preference is given to neutral reactive complexes of platinum with vinylsiloxanes, such as sym-divinyltetramethyldisiloxane.

The amount of the dehydrogenolysis catalyst (C) required is governed by the desired rate of reaction and by economic factors. Per 100 parts by weight of the reactive polysiloxanes (A) and (B) to be reacted, preferably 1×10⁻⁵ to 5×10⁻² parts by weight, in particular 1×10⁻³ to 1×10⁻² parts by weight of platinum catalysts, calculated as platinum metal, are usually used.

The condensation of the reactive polysiloxanes (A) and (B) by dehydrogenolysis is preferably carried out at temperatures of from −30° C. to +180° C. The reaction is more preferably carried out at temperatures from 20° C. to 80° C.

By suitably adjusting the stoichiometry of the reactive groups of the chain ends of the polysiloxanes (A) and (B) it is possible to achieve copolysiloxanes of high molecular weight. The linear-chain copolysiloxanes preferably have molecular weights of from 1000 to 1,000,000 g/mol. In the above formulae, combinations of symbols which give —O—O— groups are excluded. All of the remaining symbols in the above formulae have their meanings independently of one another.

In the examples below, unless otherwise stated, all pressures are 0.10 MPa (abs.), and all temperatures are 20° C.

### EXAMPLE 1

A 250 ml three-necked flask with internal thermometer and nitrogen blanketing is charged, at 25° C., with 100.0 g of hydroxysilyl-terminated polydimethylsiloxane having a viscosity of 49 mPa·s and an average degree of polymerization, determined by means of ²⁹Si-NMR spectroscopy, of 35.7 dimethylsiloxane units. The polydimethylsiloxane has been neutralized beforehand with 0.2% by weight of ammonium hydrogen carbonate, and freed from dimethylsiloxane cyclics and water using a thin-layer evaporator at 150° C. and a vacuum of 0.5 mbar. 0.033 g (50 ppm of Pt) of a catalyst solution consisting of 85% by weight of toluene and 15% by weight of platinum divinyltetramethyldisiloxane complex (Karstedt catalyst) is metered in. Over the course of 60 min, a total of 7.35 g of 1,4-bis(dimethylsilyl)benzene are metered in dropwise. The internal temperature increases during this operation to 35° C. After stirring for a further hour, the exothermic reaction has subsided and the mixture is heated for a further 1 h at an internal temperature of 50° C. and a vacuum of 1 mbar until the evolution of hydrogen has completely subsided. The viscosity of the sample increases during this operation in a clearly visible manner. The analytical data are given in Table 1.

### EXAMPLE 2

A 250 ml three-necked flask with internal thermometer and nitrogen blanketing is charged, at 25° C., with 100.0 g of hydroxysilyl-terminated polydimethylsiloxane having an average degree of polymerization, determined by means of ²⁹Si-NMR spectroscopy, of 6.7 dimethylsiloxane units. The polydimethylsiloxane has been neutralized beforehand with 0.2% by weight of ammonium hydrogen carbonate, and freed from dimethylpolysiloxane cyclics and water using a thin-layer evaporator at 150° C. and a vacuum of 0.5 mbar. 0.045 g (50 ppm of Pt) of a catalyst solution consisting of 85% by weight of toluene and 15% by weight of platinum divinyltetramethyldisiloxane complex (Karstedt catalyst) is metered in. Over the course of 3 h, a total of 37.98 g of 1,4-bis(dimethylsilyl)benzene are metered in dropwise. The internal temperature increases during this operation to 46° C. After stirring for a further 2 h, the exothermic reaction has subsided, and the mixture is heated for a further 1 h at an internal temperature of 50° C. and a vacuum of 1 mbar until the evolution of hydrogen has completely subsided. The viscosity of the sample increases during this operation in a clearly visible manner. The analytical data are given in Table 1.

TABLE 1

| | | | | ²⁹Si-NMR spectroscopy | |
|---|---|---|---|---|---|
| | | | | | In- |
| Ex- | | GPC | | | te- |
| am- | Mn | Mw | Mw/ | δ | gral |
| ple | [g/mol] | [g/mol] | Mn | [ppm] | [%] |
| 1 | 102100 | 159500 | 1.562 | −2.42 (PhSiMe₂O—SiMe₂O—) | 5.3 |
| | | | | −10.54 (HOSiMe₂O)— | <0.1 |
| | | | | −20.60 (SiMe₂O—SiMe₂Ph) | 5.3 |
| | | | | −21.9 (—SiMe₂O—) | 89.4 |
| 2 | 39900 | 58800 | 1.474 | −2.45 (PhSiMe₂O—SiMe₂O—) | 23.1 |
| | | | | −10.88 (HOSiMe₂O—) | <0.1 |
| | | | | −20.7 (SiMe₂O—SiMe₂Ph) | 22.9 |
| | | | | −22.0 (—SiMe₂O—) | 54.0 |

### EXAMPLE 3

### Preparation of a Silarylenesiloxane Compound (B)

A 250 ml three-necked flask with nitrogen blanketing is charged with 19.4 g of 1,4-bis(dimethylsilyl)benzene in 50 ml of dry THF, and 0.3 g (100 ppm of Pt, based on the total amount of starting material) of a catalyst solution consisting of 85% by weight of toluene and 15% by weight of platinum divinyltetramethyldisiloxane complex (Karstedt catalyst) is metered in. The mixture is cooled to 0° C. and, over the course of 3 h, 100 g of a solution of 98.5 g of dry THF and 1.5 g of water are metered in. Hydrogen begins to evolve immediately after the start of the metered addition. When the metered addition is complete, the mixture is stirred for a further 1 h at 25° C. The mixture is freed from solvent, yielding a pasty product of oligo[(oxydimethylsilylene)-(1,4-phenylene)(dimethylsilylene)]. The analytical data are given in Table 2.

TABLE 2

| | | | | ²⁹Si-NMR spectroscopy | |
|---|---|---|---|---|---|
| | | | | | In- |
| Ex- | | GPC | | | te- |
| am- | Mn | Mw | Mw/ | δ | gral |
| ple | [g/mol] | [g/mol] | Mn | [ppm] | [%] |
| 3 | 840 | 2200 | 1.88 | −0.68 (PhSiMe₂O—) | 83.6 |
| | | | | −16.71 (HSiMe₂Ph—) | 16.4 |

### EXAMPLE 4

A 250 ml three-necked flask with internal thermometer and nitrogen blanketing is charged, at 25° C., with 100.0 g of hydroxysilyl-terminated polydimethylsiloxane having a viscosity of 49 mPa·s and an average degree of polymerization, determined by means of ²⁹Si-NMR spectroscopy, of 35.7 dimethylsiloxane units. 0.033 g of a catalyst solution consisting of 85% by weight of toluene and 15% by weight of platinum divinyltetramethyldisiloxane complex (Karstedt catalyst) is metered in. Over the course of 60 min, a total of 46.6 g of the oligo[(oxydimethylsilylene)-(1,4-phenylene)(dimethylsilylene)] of Example 3, dissolved in 30 ml of dry THF, are metered in dropwise. The internal temperature increases during this operation to 29° C. After stirring for a further hour, the exothermic reaction has subsided, and the mixture is heated for a further 1 h at an internal temperature of 50° C. and a vacuum of 1 mbar until the evolution of hydrogen has completely subsided. The viscosity of the sample increases during this operation in a clearly visible manner. The analytical data are given in Table 3.

### EXAMPLE 5

A 250 ml three-necked flask with internal thermometer and nitrogen blanketing is charged, at 25° C., with 100.0 g of a hydroxysilyl-terminated polydimethylsiloxane having an average degree of polymerization, determined by means of ²⁹Si-NMR spectroscopy, of 6.7 dimethylsiloxane units. 0.045 g (50 ppm of Pt) of a catalyst solution consisting of 85% by weight of toluene and 15% by weight of platinum divinyltetramethyldisiloxane complex (Karstedt catalyst) is metered in. Over the course of 60 min, a total of 241.0 g of the oligo[(oxydimethylsilylene)-(1,4-phenylene)(dimethylsilylene)] of Example 3, dissolved in 150 ml of dry THF, are metered in dropwise. The internal temperature increases during this operation to 34° C. After stirring for a further 2 h, the exothermic reaction has subsided, and the mixture is heated for a further 1 h at an internal temperature of 50° C. and a vacuum of 1 mbar until the evolution of hydrogen has completely subsided. The viscosity of the sample increases during this operation in a clearly visible manner. The analytical data are given in Table 3.

TABLE 3

| | | | | ²⁹Si-NMR spectroscopy | |
|---|---|---|---|---|---|
| | | | | | In- |
| | | GPC | | | te- |
| | Mn | Mw | Mw/ | δ | gral |
| Ex. | [g/mol] | [g/mol] | Mn | [ppm] | [%] |
| 4 | 56300 | 102500 | 1.82 | —0.72 (PhSiMe₂O—SiMe₂Ph) | 20.9 |
| | | | | —2.40 (PhSiMe₂O—SiMe₂O—) | 4.1 |
| | | | | —10.72 (HOSiMe₂O—) | <0.1 |
| | | | | —20.60 (SiMe₂O—SiMe₂Ph) | 4.0 |
| | | | | —21.84 (—SiMe₂O—) | 71.0 |
| 5 | 34300 | 54900 | 1.60 | —0.73 (PhSiMe₂O—SiMe₂Ph) | 48.4 |
| | | | | —2.45 (PhSiMe₂O—SiMe₂O—) | 9.7 |
| | | | | —10.90 (HOSiMe₂O—) | <0.1 |
| | | | | —20.64 (SiMe₂O—SiMe₂Ph) | 9.5 |
| | | | | —22.1 (—SiMe₂O—) | 32.4 |

The values given in Tables 1 and 3 for the gel permeation chromatograms of the copolysiloxanes prepared are proof of the applicability of the process according to the invention for achieving high molecular weight of the desired copolysiloxanes. Thus, the copolymer prepared under Example 1 and having a molecular weight of 102100 is the result of the dehydrogenolysis reaction of approximately 35 hydroxy-terminated oligodimethylsiloxane chains with the equivalent amount of 1,4-bis(dimethylsilyl)benzene. Likewise, the use of hydridosilyl-terminated oligosilarylenes produces high molecular weights, as shown in Examples 4 and 5.

The values given in Examples 4 and 5 for the ²⁹Si-NMR spectroscopy provide evidence for the high selectivity of the formation reaction of the copolymers of the process according to the invention. The nuclear magnetic resonance signals detected prove that during the transition-metal-catalyzed dehydrogenolysis reaction of the hydroxysilyl-terminated dimethylsiloxane blocks with the hydridosilyl-terminated silarylene blocks, only the linking of the terminal silicon atoms with formation of a siloxane bond takes place. If the integration values of Examples 4 and 5 are used as the basis, then block lengths and their molecular weights which form the copolymer are identical to those of the reactive oligomers used. This proves that the process according to the invention excludes rearrangements of the copolymer chain and equilibration reactions between the various copolymer blocks. The high selectivity of the process according to the invention ensures the preparation of defined copolymers from dimethylsiloxane and silarylene blocks with retention of the molecular weights and of the sequence lengths of the oligomers used.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. The terms “a” and “an” when used in the claims mean “at least one” unless clearly indicated otherwise. By “O-, N-, S- or P-atom-containing” is meant that the particular moiety may contain one or more of each of these heteroatoms.

What is claimed is:

1. A process for the preparation of linear-chain copolysiloxanes comprising units of the general formulae (1) and (2),
[—(R¹R²SiO)ₐ—] (1),
[—(R³R⁴Si—R⁷—SiR⁵R⁶O)_{b}—R³R⁴Si—R⁷—SiR⁵R⁶—] (2),
the end-groups of which copolysiloxanes are selected from Si—H and Si—OH functional end groups, said process comprising reacting
(A) a diorganopolysiloxane of the general formula (3)
HO—(R¹R²SiO)ₐ—H (3)
with
(B) a silarylenesiloxane compound of the general formula (4)
H—[(R³R⁴Si—R⁷—SiR⁵R⁶O)_{b}—R³R⁴Si—R⁷—SiR⁵R⁶]—H (4),
where, in the formulae (1) to (4),
R¹ and R² are independently monovalent, optionally halogen-substituted, optionally O-, N-, S-, or P-atom-containing, optionally aliphatically unsaturated C₁₋₂₀ hydrocarbon radicals;
R³, R⁴, R⁵ and R⁶ are independently monovalent, optionally halogen-substituted, optionally O-, N-, S-, or P-atom-containing, optionally aliphatically or aromatically unsaturated C₁₋₂₀ hydrocarbon radicals;
R⁷ is a divalent, aromatically unsaturated, optionally halogen-substituted, optionally O-, N-, S- or P-atom-containing C₆₋₁₀₀ hydrocarbon radical;
a is an integer from 1 to 1000 and
b is an integer from 0 to 100, in the presence of
(C) a transition metal catalyst.

2. The process of claim 1, wherein the transition metal catalyst (C) comprises platinum, a platinum compound, or a mixture thereof.

3. The process of claim 1, in which R¹, R², R³,R⁴,R⁵ and R⁶ are hydrocarbon radicals having 1 to 10 carbon atoms.

4. The process of claim 1, wherein R¹ and R² are methyl.

5. The process of claim 1, wherein R⁷ is phenyl.

6. The process of claim 1, wherein R⁷ has the formula (5)
—(O)ₛ—(R⁸)ₜ—(O)ᵤ—(X)_{w}—(O)ᵤ—(R⁸)ₜ—(O)ₛ—, (5),
where
s and u are 0 or 1,
t is 0, 1 or 2,
w is 1 or 2,
R⁸ is a bivalent, optionally halogen-substituted, optionally O-, N-, S- or P-atom-containing hydrocarbon radical free from aliphatically unsaturated groups and containing 1 to 10 carbon atoms, and
X is a bivalent radical chosen from —Ph—, —Ph—O—Ph—, —Ph—S—Ph—, —Ph—SO₂—Ph—, —Ph—C(CH₃)₂—Ph—, Ph—C(CF₃)₂—Ph—, —Ph—C(O)—Ph—, cyclohexylene or norbornylene, where —Ph— is a phenylene group.

7. The process of claim 1, wherein the viscosities of the Si—OH functional diorganopolysiloxanes of the formula (3) and the silarylenesiloxane compounds of the formula (4) are from 1 mPa·s to 1,000,000 mPa·s measured at 25° C.

8. The process of claim 1, wherein the viscosities of the Si—OH functional diorganopolysiloxanes of the formula (3) and the silarylenesiloxane compounds of the formula (4) are from 2 mPa·s to 100,000 mPa·s measured at 25° C.
